(19) United States
(12) Patent Application Publication
(10) Pub. No.: US 2024/0336377 A1
(43) Pub. Date: Oct. 10, 2024

(54) FLYING VEHICLE

(71) Applicant: AERONEXT INC., Tokyo (JP)

(72) Inventor: Yoichi SUZUKI, Tokyo (JP)

(21) Appl. No.: 18/579,284

(22) PCT Filed: Jul. 13, 2021
(86) PCT No.: PCT/JP2021/026232

§ 371 Date: Jan. 12, 2024

(51) Int. Cl. B64U 10/60; B64D 1/22; B64U 10/14; B64U 101/67

(52) U.S. Cl. CPC B64U 10/60; B64D 1/22; B64U 10/14; B64U 2101/67

(57) ABSTRACT

The invention is a flying vehicle comprising a suspension member for suspending a load, wherein the suspension member comprising a first portion and a second portion comprising a different configuration from the first portion, which is to be grasped. Furthermore, the first portion and the second portion are different cord-like members and are connected to each other. Furthermore, the second portion is made of a thicker member than the first portion. The second portion is covered by said covering member. Furthermore, the second portion comprises a higher coefficient of friction than the first portion.

### TECHNICAL FIELD

This invention relates to flying vehicles.

### BACKGROUND ART

In recent years, the practical application of home delivery services using flying vehicles such as drones and unmanned aerial vehicles (UAVs; hereinafter collectively referred to as “flying vehicles”) has been in progress. Flying vehicles equipped with multiple propellers, commonly called multicopters (hereinafter collectively referred to as “multicopters”), do not require a runway for takeoff and landing like ordinary fixed-wing aircraft, allowing them to operate in relatively small areas and making them suitable for providing home delivery and other transportation services.

In transportation by flying vehicles, it is known that when detaching a load from a flying vehicle, the flying vehicle lands at a port or other location, where the load is released from its hold and landed on the spot, or a person removes the load from the flying vehicle.

However, it is known that the landing operation, which involves vertical descent of the flying vehicle, tends to make the flying vehicle more unstable than the cruising operation, etc. In addition, a person needs to approach and contact its airframe in order to remove loads. In view of this situation, Patent Literature 1 discloses a luggage delivery system using a flying vehicle, in which luggage is suspended from the flying vehicle and lowered, so that the luggage can be detached without the flying vehicle having to land (see, for example, Patent Literature 1).

### PRIOT ART LIST

### Patent Literature

[Patent Literature 1] US20200207474A1
[Patent Literature 2] JP2019-001309A

### SUMMARY OF THE INVENTION

### Technical Problem

Patent Literature 1 discloses a flying vehicle-based load delivery system in which the flying vehicle is connected to the load with a cable, wherein the cable is unloaded by unrolling the load toward the ground, and the load is automatically released from the cable when the load reaches the ground.

When unloading a load by suspending it from a flying vehicle in the sky, it may be difficult to improve the positioning accuracy of the load. For example, environmental winds and the movement of flying objects can cause swaying and misalignment of loads suspended from cables in some cases. In addition, when GNSS is used to control the position of flying vehicles, the positional accuracy may vary depending on the satellite supplementation status.

If the load is to be cut off at a large port or on the ground, misalignment of the load is unlikely to be a problem. However, when loads are to be landed on narrow land or compact ports, improved accuracy in the positioning of loads is required.

For the purpose of limiting the amount of movement of flying vehicles, area-limiting means using a mooring member and a winding device are disclosed, as in Patent Literature 2.

However, in applications such as home delivery and inspection and the like, flying vehicles are required to fly over a wide area, and it is difficult for them to perform their tasks while moored at a single point. Therefore, one purpose of this invention is to provide a position restriction system that enables temporary area restriction at a predetermined point, such as a takeoff/landing point, without constant mooring during flight.

### Technical Solution

According to the invention, it is possible to provide a flying vehicle that suspends a mount via a suspension member, wherein the suspension member comprises a first portion and a second portion that is different from the first portion and is to be grasped.

Other issues disclosed in this application and their solutions will be clarified in the “Embodiments of the Invention” section and in the drawings.

### Advantageous Effects

According to the invention, it is possible to provide a flying vehicle equipped with a suspension member for suspending a load, wherein the suspension member comprises a first part that reduces the overall weight of the suspension member and a second part that enables easy external grasping of the suspension member.

### BRIEF DESCRIPTION OF THE DRAWINGS

FIG. 1 is a schematic diagram of the position restriction according to the invention, viewed from the side.

FIG. 2 is a view of the position restriction device of FIG. 1 in use.

FIG. 3 is a schematic view of the position restriction device of FIG. 1 from the top.

FIG. 4 is a schematic view of the position restriction device of FIG. 2 from the top.

FIG. 5 is another top view of an example of a position restriction device.

FIG. 6 is another top view of an example of a position restriction device.

FIG. 7 is another top view showing an example of a position restriction device.

FIG. 8 is an example of the operation of the position restriction device of FIG. 7.

FIG. 9 is a side view of a flying vehicle that can be used in combination with the invention.

FIG. 10 is a top view of the flying vehicle of FIG. 12.

FIG. 11 is a functional block diagram of the flying vehicle of FIG. 1.

FIG. 12 is a side view of a flying vehicle comprising a suspension member connected to the flying vehicle.

FIG. 13 is a side view comprising an example of a suspension connected to a flying vehicle.

FIG. 14 is an example of a cross-sectional view of a suspension member.

FIG. 15 is an example of a cross-sectional view of a suspension member.

FIG. 16 is an example of a cross-sectional view of a suspension.

FIG. 17 is a side view of an example of a suspension member.

FIG. 18 is a side view of an example of a suspension member.

FIG. 19 is a side view of an example of a suspension connected to a flying vehicle.

FIG. 20 is the suspension member of FIG. 19 when it is unwound.

FIG. 21 is a side view of an example configuration of a position restriction device according to the invention.

FIG. 22 is a front view of the position restriction device of FIG. 21.

FIG. 23 is the position restriction device of FIG. 22 in use.

FIG. 24 is a side view of an example configuration of a mounting part equipped with suspension movement means.

FIG. 25 is a side view of an example configuration of a mounting part equipped with suspension movement means.

FIG. 26 is a side view illustrating an example configuration of a position restriction device according to the invention.

FIG. 27 is a view of the position restriction device of FIG. 26 in use.

FIG. 28 is a view of the suspension member according to the invention when it is grasped by a person.

FIG. 29 is an example of a suspension member with second parts in multiple locations.

### EMBODIMENT OF THE INVENTION

The contents of the embodiments of the present invention are described and listed as follows. The flight vehicle according to the embodiment of the invention has the following configuration.

### [Item 1]

A flying vehicle suspending a load via a suspension member,
wherein the suspension member comprises a first portion and a second portion which is different in configuration from the first portion and which is to be grasped.

### [Item 2]

The flying vehicle according to item 1,
wherein the first portion and the second portion are different cord-like members and are connected to each other.

### [Item 3]

The flying vehicle as in item 1 or item 2,
wherein the second portion is comprised of a member that is thicker than the first portion.

### [Item 4]

The flying vehicle as in any one of items 1 to 3,
wherein the second portion is covered by the covering member.

### [Item 5]

The flying vehicle according to any one of items 1 to 4,
wherein the second portion comprises a higher coefficient of friction than the first portion.

### [Item 6]

The flying vehicle according to item 1,
wherein the first portion and the second portion have a common cord-like member,
wherein the second portion has a member covering the common cord-like member.

### [Item 7]

The flying vehicle according to item 6,
wherein the member covering the common cord-like member is a covering member with a high coefficient of friction.

### [Item 8]

The flying vehicle as in item 6 or item 7,
wherein the member covering the common cord-like member is a member with a concave-convex shape on the surface.

### [Item 9]

The flying vehicle according to any one of items 1 or 8,
wherein the cross-sectional shape of the second portion is different from the cross-sectional shape of the first portion.

### [Item 10]

The flying vehicle according to item 9,
wherein the cross-sectional shape of the second portion is polygonal.

### [Item 11]

The flying vehicle as in any one of items 1 to 10,
wherein the second portion is provided in the vicinity of the load.

### [Item 12]

The flying vehicle as in any one of items 1 to 11,
wherein the suspension member is connected to a loading part that carries the load.

### [Item 13]

The flying vehicle according to item 12,
wherein the mounting part is equipped with a rotary wing part.

### [Item 14]

The flying vehicle as in items 12 or 13,
wherein the suspending member comprises:
a first suspending member between the flying vehicle and the loading part; and
a second suspending member between the loading part and the load.

### [Item 15]

The flying vehicle according to item 14,
wherein the first suspension member and the second suspension member both have the second portions.

### [Item 16]

The flying vehicle according to item 14,
wherein the first suspension member has the second portion,
wherein the second suspension member does not have the second portion.

### [Item 17]

The flying vehicle according to item 14,
wherein the first suspension member does not have the second portion,
wherein the second suspension member has the second portion.

### Details of Embodiments According to this Disclosure

The flying vehicle according to this embodiment of the invention is described below with reference to the drawings.

### Details of the First Embodiment

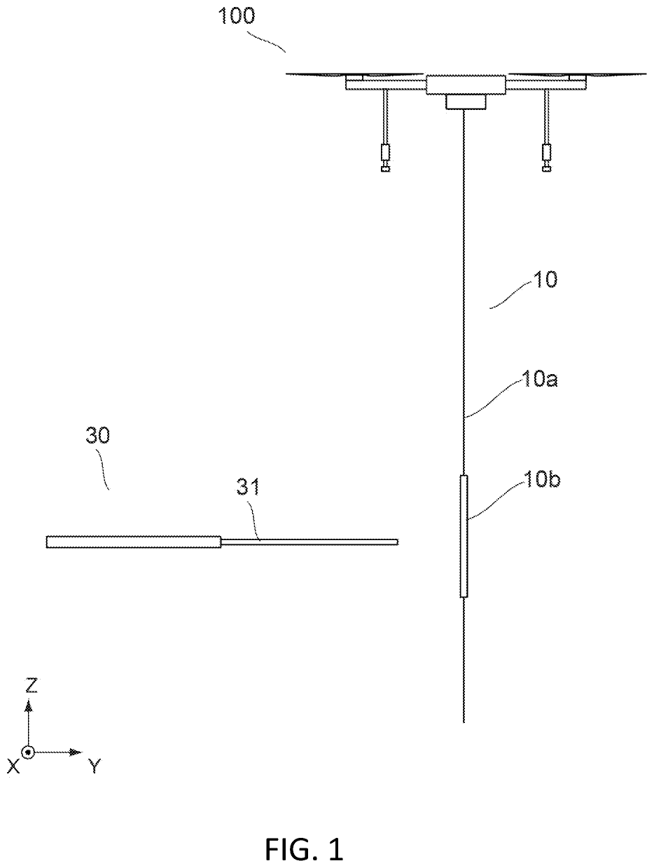

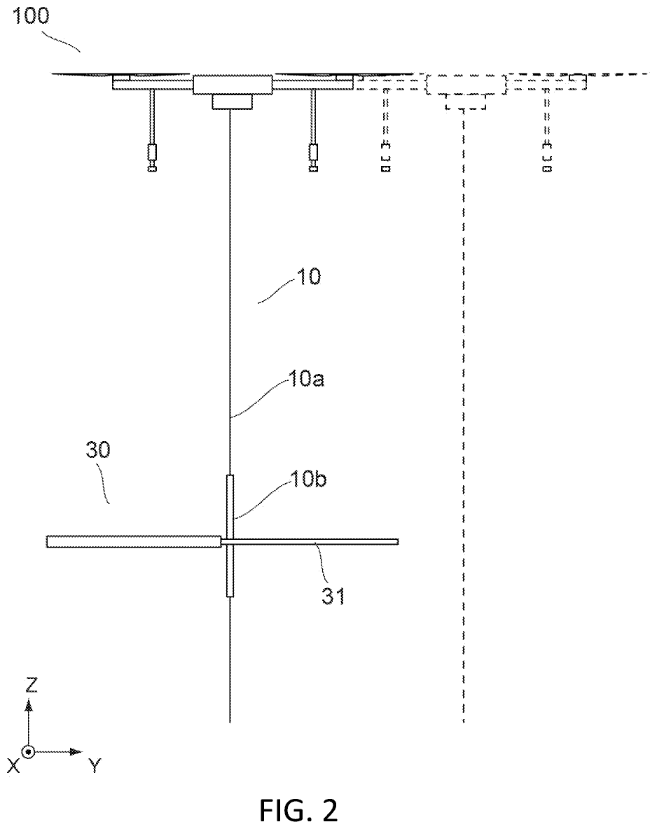

As illustrated in FIG. 1 and FIG. 2, the flying vehicle 100 is connected to a suspension member 10 that can be grasped by the position restriction device 30 or a person, and the movement of the flying vehicle is restricted by restricting the movement of the suspension member 10. The location of the suspension member 10 connected to the flying vehicle 100 should be at a location where the flying vehicle will not become unstable due to the grasping (e.g., where the suspension member passes through the center portion of the flying vehicle when viewed from above or below the flying vehicle, especially the center portion of the bottom of the flying vehicle).

By limiting the amount and direction in which the flying vehicle 100 can move by means of the position restriction device 30, the flying vehicle 100 and the load 11 are restricted in their movement even if they are affected by the environment, such as wind, or by a control failure of the flying vehicle 100. As a result, the displacement of each part is reduced, and if, for example, the load 11 is a package to be delivered, it is easier to detach the load to a compact port or other location without the flying vehicle landing. Also, when the flying vehicle performs a landing, the descent and landing movements are performed with the range of movement restricted, so that the safety of the surrounding area can be expected to be secured even when the flying vehicle becomes unstable.

The flying vehicle 100 performs takeoff from the takeoff point and flies to its destination. For example, when the flying vehicle 100 makes a delivery, the flying vehicle 100 that reaches the destination completes the delivery by landing at a port or other location or detaching its load. After detaching the load, the flying vehicle 100 heads to another destination and performs a move.

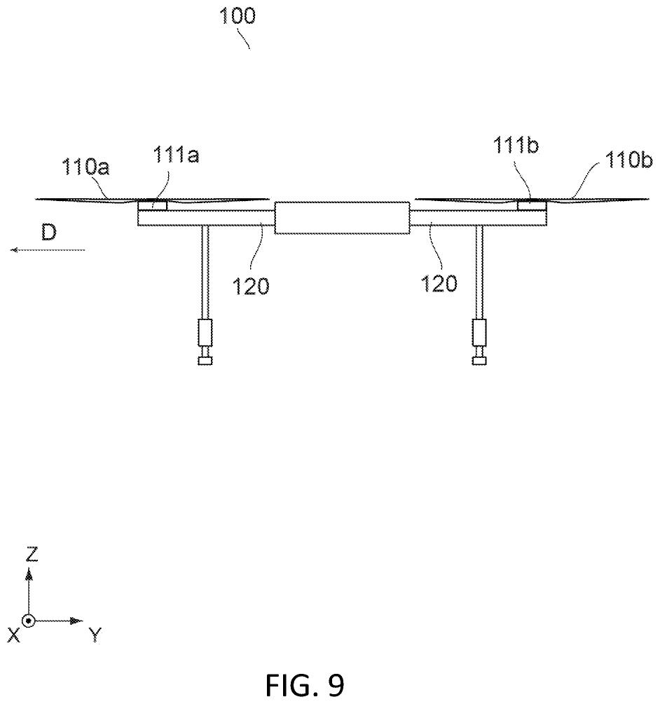

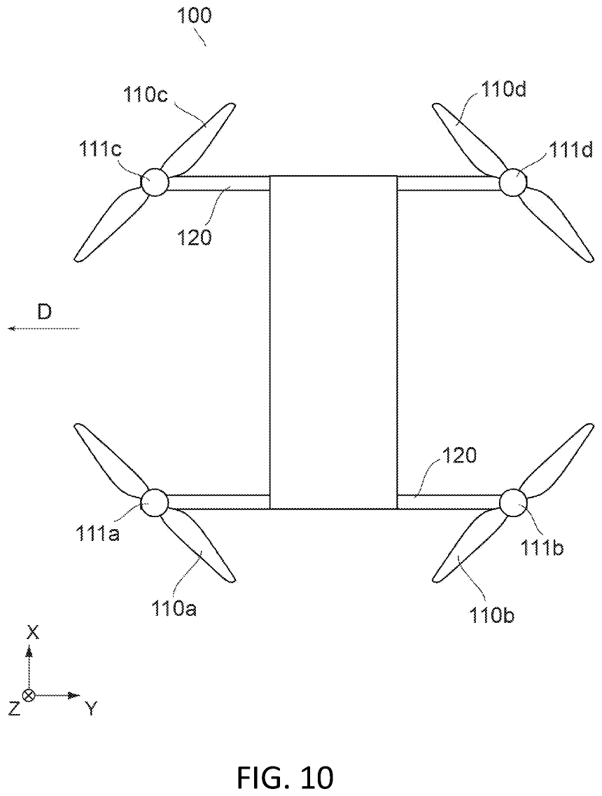

As shown in FIG. 9 and FIG. 10, the flying vehicle 100 according to this embodiment has at least a main body part for flight, a plurality of rotary wing parts comprising a propeller 110 and a motor 111, a motor mount and frame 120 that support the rotary wing parts, and other elements. And it should be equipped with energy (e.g., secondary batteries, fuel cells, fossil fuels, etc.) to operate them.

The flying vehicle 100 shown in the figures is depicted in a simplified manner to facilitate the explanation of the invention's structure, and detailed components such as the control part, for example, are not shown in the figures.

The flying vehicle 100 is moving forward in the direction of arrow D (−Y direction) in FIG. (see below for details).

In the following explanation, the terms may be used according to the following definitions. Forward and backward: +Y and −Y, up and down (or vertical): +Z and −Z, left and right (or horizontal): +X and −X, forward direction (forward): −Y, rearward direction (backward) direction (backward): +Y direction, ascending direction (upward): +Z direction, descending direction (downward): −Z direction.

The propeller 110 rotates under the output from the motor 111. The rotation of the propeller 110 generates propulsive force to take the flying vehicle 100 off from its starting point, move it, and land it at its destination. The propeller 110 can rotate to the right, stop, and rotate to the left.

The propeller 110 provided by the flying vehicle of the invention has one or more blades. Any number of blades (rotors) (e.g., 1, 2, 3, 4, or more blades) is acceptable. The shape of the blades can be any shape, such as flat, curved, kinked, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) as the blades are moved through the air. The geometry of the blade/vane can be selected as appropriate to optimize the dynamic aerodynamic characteristics of the vane, such as increasing lift and thrust and reducing drag.

The propeller provided by the flying vehicle of the invention may be, but is not limited to, fixed pitch, variable pitch, or a mixture of fixed and variable pitch.

The motor 111 produces rotation of the propeller 110; for example, the drive unit can include an electric motor or engine. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving object (e.g., size, weight) and the control conditions (speed, direction of movement, etc.).

The flying vehicle 100 determines the number of revolutions of each motor and the angle of flight according to the wind speed and direction by means of a flight controller or propo/radio. This allows the flying vehicle to perform movements such as ascending and descending, accelerating and decelerating, and changing direction.

The flying vehicle 100 can fly autonomously according to routes and rules set in advance or during the flight, or by using a propo/radio to control the flying vehicle.

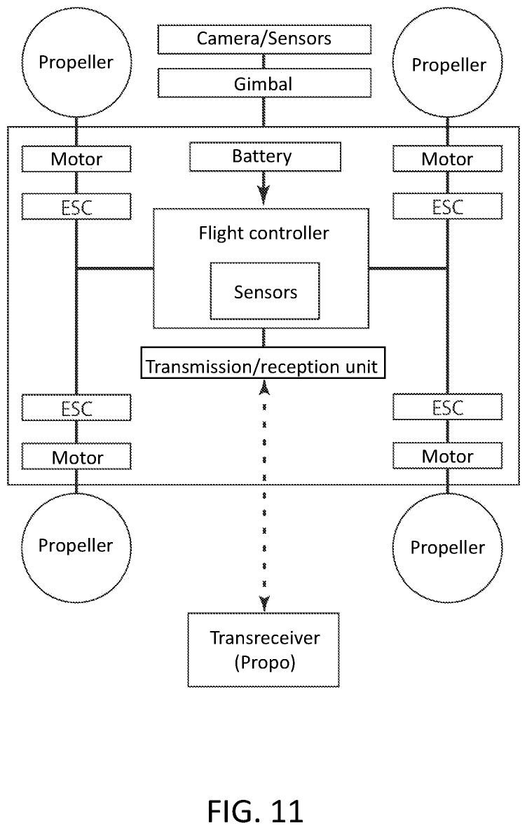

The flying vehicle 100 described above has the functional blocks shown in FIG. 11. The functional blocks in FIG. 11 are a minimum reference configuration. The flight controller is a so-called processing unit. The processing unit can have one or more processors, such as a programmable processor (e.g., central processing unit (CPU)). The processing unit has a memory, not shown, which is accessible. The memory stores logic, code, and/or program instructions that can be executed by the processing unit to perform one or more steps. The memory may include, for example, a separable medium such as an SD card, random access memory (RAM), or an external storage device. Data acquired from cameras and sensors may be directly transmitted to and stored in the memory. For example, still and moving image data captured by a camera or other device is recorded in the internal or external memory.

The processing unit includes a control module comprising to control the state of the rotorcraft. For example, the control module controls the propulsion mechanism (e.g., motor) of the rotorcraft to adjust the spatial arrangement, velocity, and/or acceleration of the rotorcraft having six degrees of freedom (translational motion x, y and z, and rotational motion θx, θy and θz). The control module can control one or more of the states of the loading part, sensors, etc.

The processing unit is capable of communicating with a transmission/reception unit comprised of one or more external devices (e.g., terminal, display, or other remote controller) to transmit and/or receive data. The transceiver can use any suitable means of communication, such as wired or wireless communication. For example, the transmission/reception unit can use one or more of the following: local area network (LAN), wide area network (WAN), infrared, wireless, WiFi, point-to-point (P2P) network, telecommunications network, or cloud communications. The transmission/reception unit can transmit and/or receive one or more of the following: data acquired by sensors or the likes, processed results generated by the processing unit, predetermined control data, user commands from a terminal or remote controller, and so on.

Sensors in this embodiment can include inertial sensors (accelerometers, gyroscopes), GPS sensors, proximity sensors (e.g., lidar), or vision/image sensors (e.g., cameras).

The plane of rotation of the propeller 110 provided by the flying vehicle 100 in this embodiment is at a forward inclined angle toward the direction of travel when traveling. The forward inclined rotating plane of the propeller 110 generates upward lift and thrust in the direction of travel, which propels the flying vehicle 100 forward.

The flying vehicle 100 may be equipped with a main body part that can contain the onboard processing unit, battery, and other components. The main body part can optimize the shape of the flying vehicle 100 in its attitude during cruising, which is expected to be maintained for a long time during the movement of the flying vehicle 100, and increase the flight speed, thereby efficiently reducing the flight time.

The main body part should have an outer skin that is strong enough to withstand flight, takeoff and landing. For example, plastic, FRP, etc. are suitable materials for the outer skin because of their rigidity and water resistance. These materials may be the same material as the frame 120 (including arms) included in the flight part, or they may be different materials.

The motor mount, frame 120, and main body part provided by the flight part may comprise connected parts, or they may be molded as a single unit using a monocoque structure or integral molding (e.g., the motor mount and frame 120 are molded as a single unit, the motor mount, frame 120, and main body part are molded as a single unit, etc.). all main body parts molded as one piece, etc.). By integrating the parts as one piece, the joints between each part can be made smooth, which is expected to reduce drag and improve fuel efficiency of flying vehicles such as blended wing bodies and lifting bodies.

The shape of the flying vehicle 100 may be directional. For example, the flying vehicle 100 may have a streamlined main body part that has less drag in a cruising attitude in no wind, or other shapes that improve flight efficiency when the nose of the flying vehicle is facing directly into the wind.

The suspension member 10 connected to the flying vehicle comprises a first portion 10a and a second portion 10b that differ from each other.

The first portion 10a is a cord-like member and should be lightweight to reduce the load on the flying vehicle 100 that is flying with the first portion 10a connected. Furthermore, when it is provided with strength to withstand the propulsive force of the flying vehicle 100 or the weight of its load, it can prevent the flying vehicle 100 or its load from being unintentionally released.

Examples of materials used for the first portion 10a of the suspension member include a rope made of cotton, hemp or the like, or a high-strength line member made of nylon, fluorocarbon, polyester, polyethylene, or other resin. In the case of using an electric wire or the like made of copper or aluminum wire, it is possible to feed power through the suspension member 10.

However, the thinness of the first portion 10a may become an obstacle when a port or a person grasps the suspension member 10 or when a flying vehicle or load is raised or lowered by applying pressure to the suspension member 10. By making the first portion 10a thicker, gripping and the like can be performed easily. If a thicker member is used, the weight and air resistance of the suspension member 10 will increase, which may cause an increased load on the flying vehicle 100, causing the suspension member 10 to sag and the load to swing downwind, making it difficult to balance the ease of grasping and other operations.

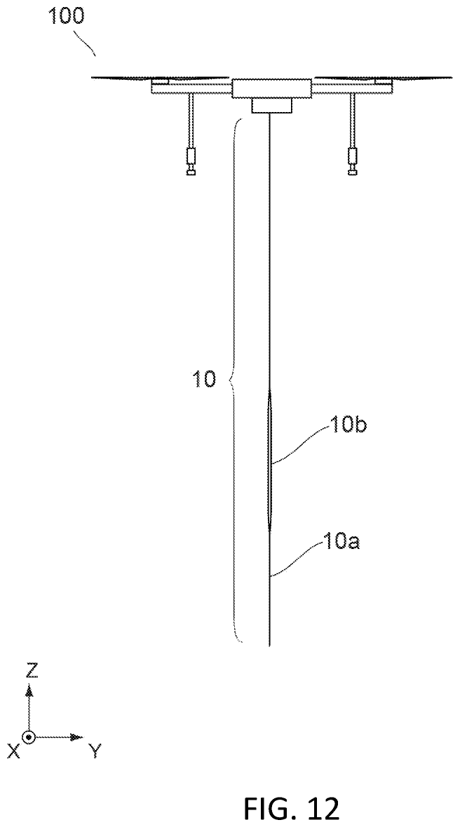

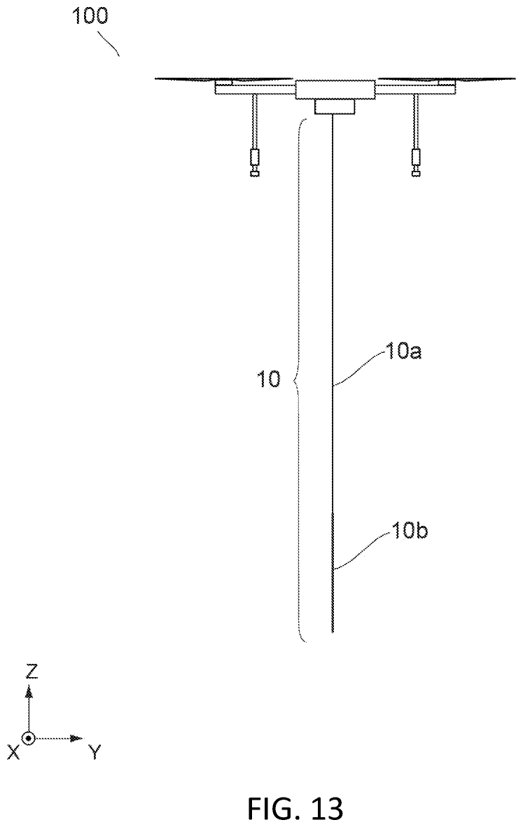

Therefore, the suspension member 10 in the invention comprises a second portion 10b that differs from the first portion 10a only in the predetermined area of the suspension member 10 where grasping is performed, as illustrated in FIGS. 12 and 13, to facilitate grasping with a minimum increase in weight and air resistance.

The second portion 10b should be a member comprising different from the first portion 10a (e.g., different in thickness, cross-sectional shape, surface or all materials, etc.) and should have a higher coefficient of friction or larger area on the surface than the first portion.

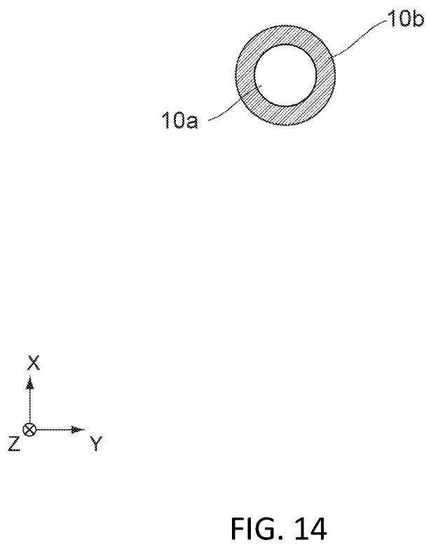

When the first portion 10a and the second portion 10b comprise the same material, the thickness of the second portion 10b should be thicker than that of the first portion 10a, as illustrated in FIG. 14-FIG. 16. This makes it possible to minimize the increase in the free volume of the suspension member while making it easier to grasp, etc., preventing the member from being dropped, and improving the reliability of the mooring. The same effect can also be expected by changing the material of the second portion 10b.

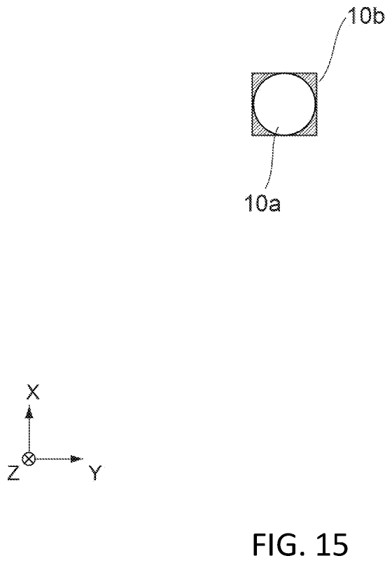

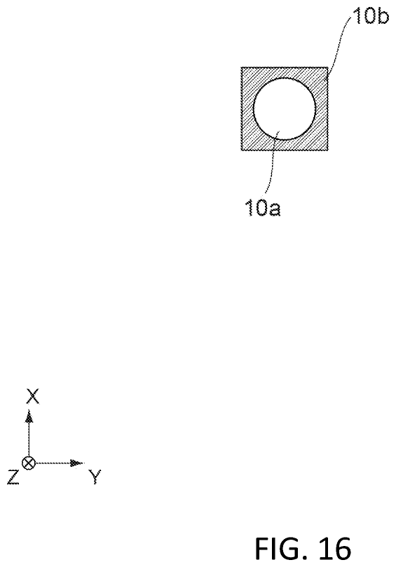

When changing the material of the second portion 10b, a material with a higher coefficient of surface friction (e.g., a cable coated with rubber, silicone, vinyl, etc., or a rope made of cotton or metal laminated together) is used in the first portion 10a and the second portion 10b than in the first portion 10a. In particular, the second portion 10b may have a circular cross-sectional shape as illustrated in FIG. 14, but may be easier to grasp if it has a polygonal cross-sectional shape as illustrated in FIGS. 15 and 16.

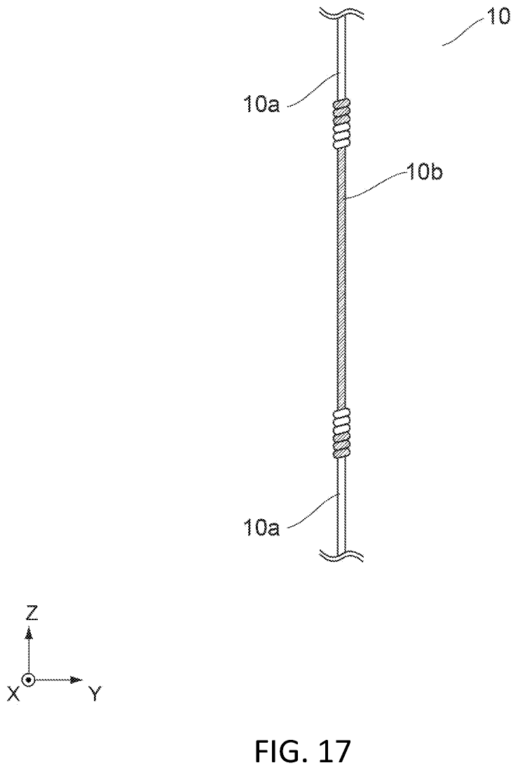

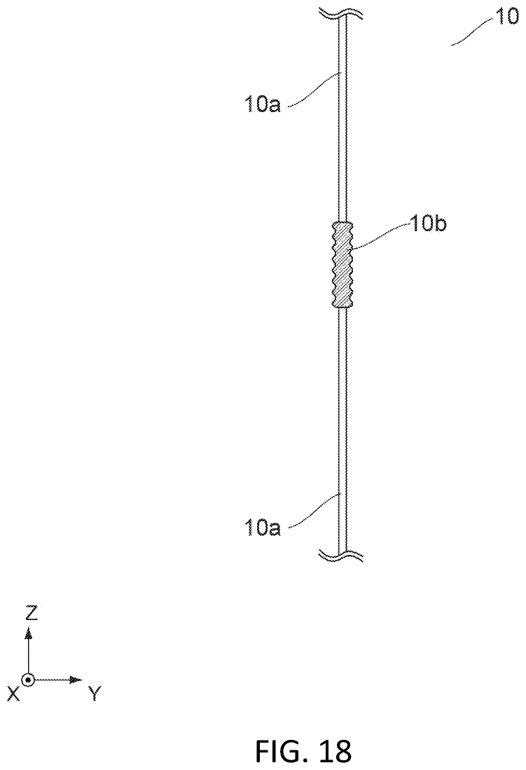

As an example of a specific configuration, as shown in FIG. 17, the first portion 10a comprises a fishing line made of polyethylene and the second portion 10b comprises a rope made of a vinylon-polyester blend yarn. In this case, the second portion 10b is thicker and has a stronger coefficient of friction than the first portion 10a. As shown in FIG. 18, a configuration in which the first portion 10a is a cord-like member and the second portion 10b comprises a molded resin part with a high gripping force (especially, a part with an uneven surface) is used. In this case, the second portion 10b is thicker and has a stronger coefficient of friction than the first portion 10a. However, since the flexibility of the second portion 10b is reduced compared to the case where a cord-like material is used for the second portion 10b, it may be difficult to wind up the second portion 10b with a winch or the like when accompanied by a winch or the like.

The second portion 10b, comprising the same material as the first portion 10a, may be coated with a material with a higher coefficient of friction to increase the frictional force and at the same time increase the diameter.

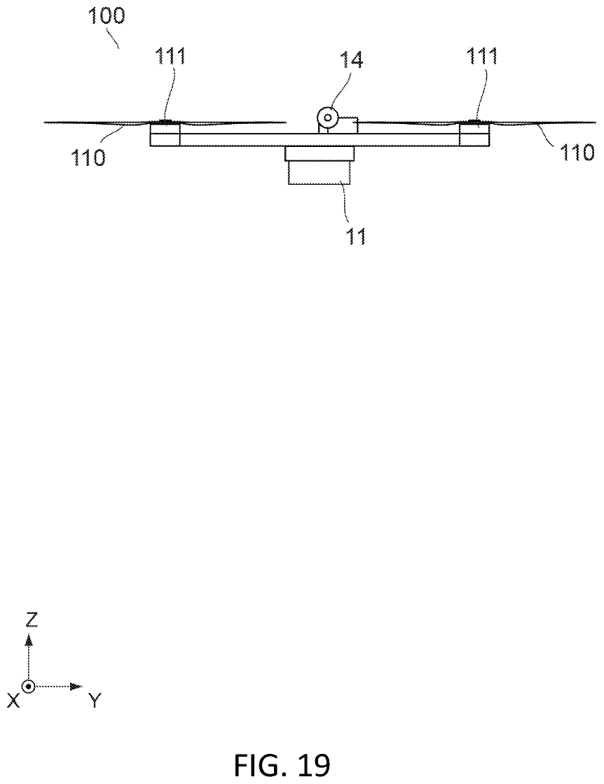

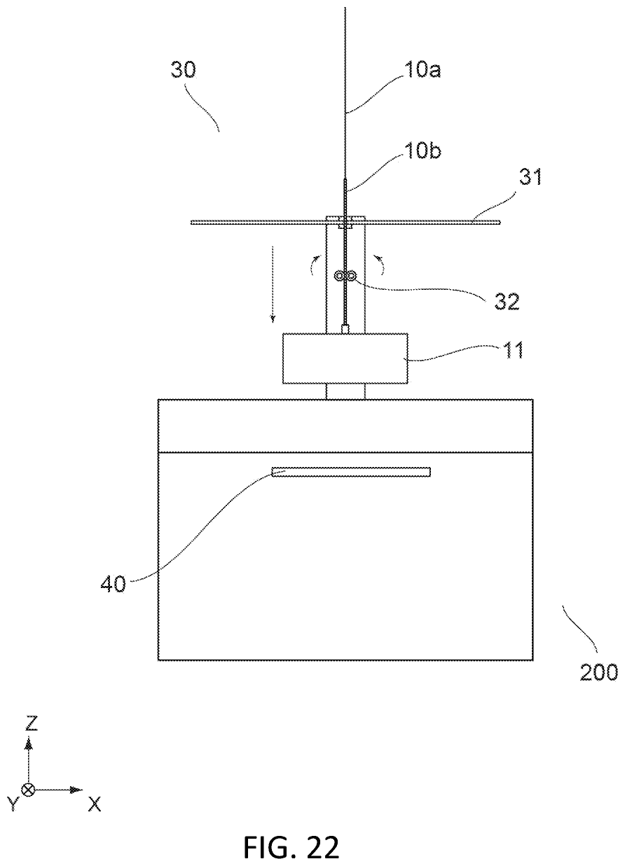

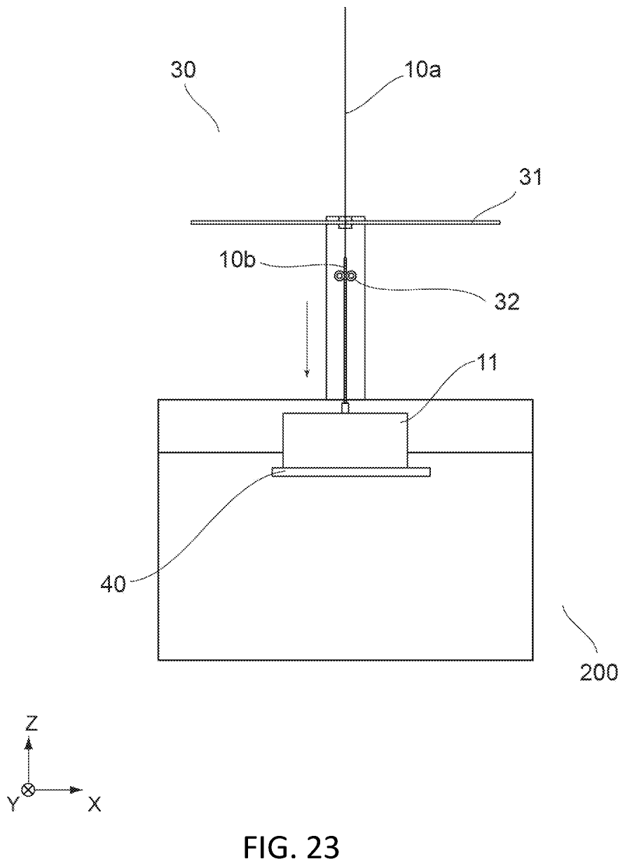

The location and extent of the second portion 10b is determined by the application of the flying vehicle 100. For example, as shown in FIG. 19-FIG. 25, in a system in which the flying vehicle 100 that performs home delivery lowers the load 11 (cargo) connected to the suspension member 10 and the port grasps the suspension member 10 to assist in unloading, the second portion 10b of the suspension member 10 that the port grasps is limited to the vicinity of the load.

As shown in FIG. 1 and FIG. 2, the suspension member 10 according to this embodiment can be used in combination with the position restriction device 30. In the following description, the flying vehicle 100 used in combination with the position restriction device 30 according to the embodiment of the invention is a multicopter as an example, but there is no limitation on the form or operation of the flying vehicle in this embodiment. For example, it goes without saying that the combination can also be used in fixed wing aircraft, VTOL aircraft, helicopters, etc.

The position restriction device 30 can restrict movement by blocking or narrowing the entry opening when the suspension member 10 enters a predetermined position, or has a structure that can pinch or grip the suspension member 10, thereby restricting the movement of the flying vehicle 100.

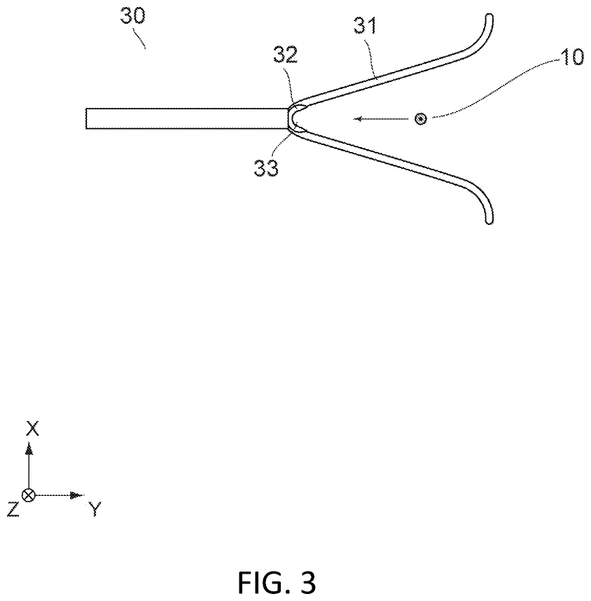

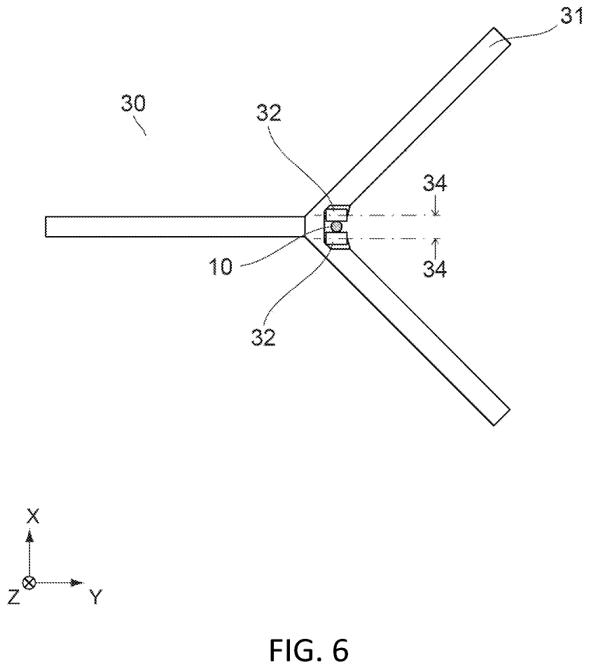

The position restriction device 30 may be provided with a guide part 31, as illustrated in FIG. 3-8, to guide the suspension member 10 so that it can easily approach parts where the position restriction by the restriction member 32 is possible. Moreover, the enclosed space 33, which is at least partially surrounded by the guide part 31 and provided with an open part into which allows the enrty of the suspension member 10, can also be used as a space to hold the suspension member 10 by operation of the restricting member 32, as shown in FIG. 3-5. The restricting member 32 can be combined with a configuration that restricts the movement of the suspension member 10 by directly gripping or otherwise restricting the suspension member 10. It is also possible to perform a first step of roughly restricting the movement of the suspension member 10 by the guide part 31 illustrated in FIG. 6-FIG. 8, and then to elaborately restrict the movement of the second part 10b of the suspension member 10 by a second step using the restricting member 32 that directly restricts the movement by gripping the second part 10b of the suspension member 10 or the like.

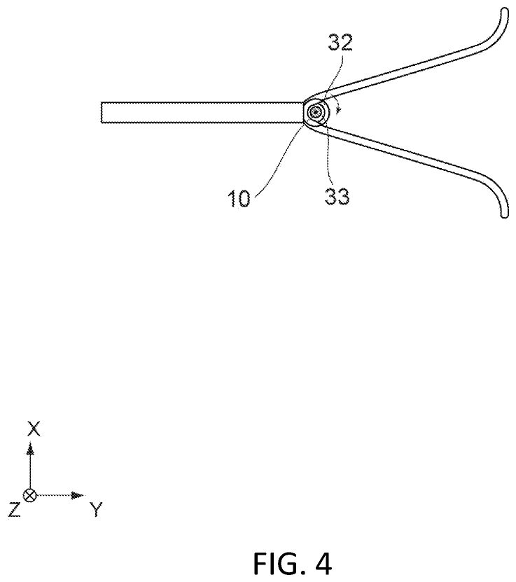

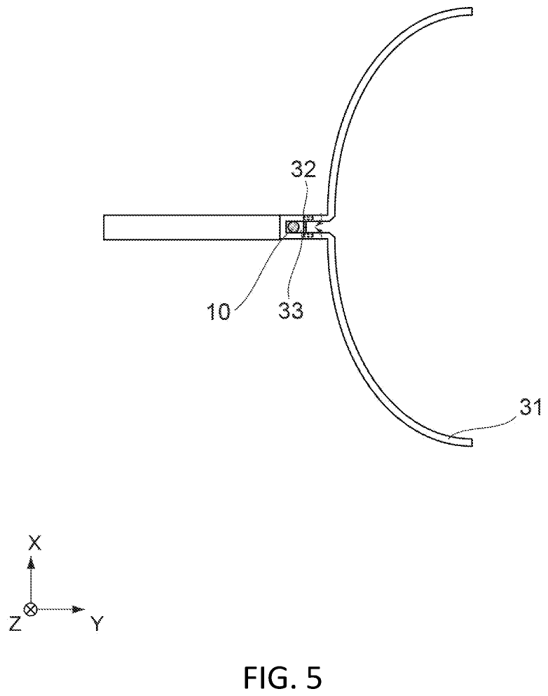

For example, as illustrated in FIG. 4 and FIG. 5, it is possible to restrict movement in the X and Y directions by blocking the entry port as a movable member such as sliding or folding the restricting member 32. The restricting member 32 shown in FIG. 3 and FIG. 4 is in the form of a ring lock, which restricts the position of the suspension member 10 by rotating the bolt when the suspension member 10 enters a predetermined position. The restricting members 32 shown in FIG. 5 is retracted with the tip facing +Y when not in use and rotates inward to restrict the position of the suspension member 10 when the suspension member 10 enters a predetermined position. When the restricting member 32 grips the suspension member 10 as shown in FIG. 6-FIG. 8, it can also restrict movement in all directions (X, Y, and Z).

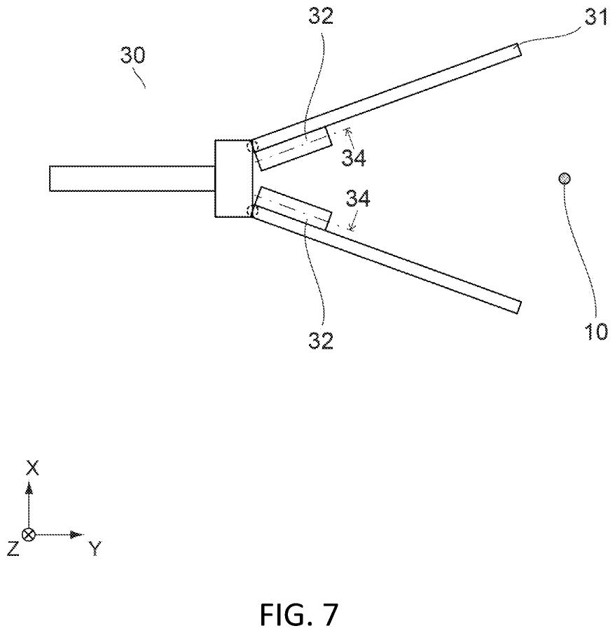

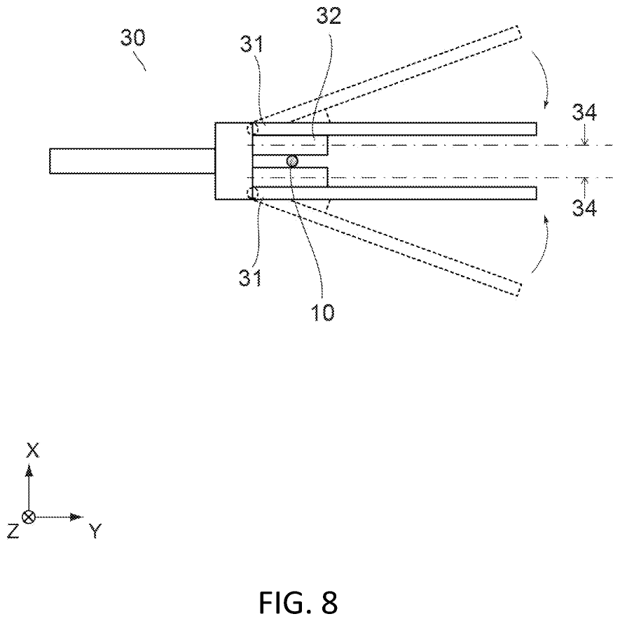

In the position restriction device 30 illustrated in FIG. 6-FIG. 8, the restriction member 32 may simply be a gripping part that grips the second portion 10b of the suspension member 10. For example, it may be a roller part of a hoisting device, and after the entry of the suspension member 10, the roller part rotates around the axis of rotation 34 to enable descent. The direction of rotation can be reversed to enable ascent. In the position restriction device 30 illustrated in FIG. 7 and FIG. 8, when the suspension member 10 is positioned within a predetermined range (in this case, the range estimated to be affected by the rotation of the roller part that has been rotated to the position shown in FIG. 8), the guide part 31 and the restricting part 32 are rotated to pinch the second part 10b of the suspension member 10, and then the roller part is rotated to enable raising and lowering. The restricting member 32 need only have the effect of restricting the movement of the suspension member 10, and the method of restriction is not limited to the above example.

When the position restriction device 30 is equipped with a roller part of a winding device as a restricting part 32, if the winding machine 14 provided by the flying vehicle 100 unrolls and winds up the suspension member 10 in accordance with the direction and speed of rotation of the roller part, the Z-directional position of the suspension member 10 and the load 11 will change without any change in the Z-directional position of the flying vehicle. If the roller part of the winding device provided by the position restriction device 30 rotates, but the winding machine 14 provided by the flying vehicle 100 does not operate, the position of the flying vehicle 100 in the Z-direction changes. By controlling the method and timing of the action of the winding device provided by the position restriction device 30 and the winding machine 14 provided by the flying vehicle 100, it is possible to control the amount and speed of movement of the flight object 100 and the loading part 11 in the Z-direction.

The position restriction device may be equipped with a sensor (e.g., optical, pressure-sensitive, or infrared sensor) or physical trigger (e.g., cable, wire, latch, etc.) to sense that the suspension member 10 has entered a predetermined position. The restricting member 32 may be operated based on the information input to the sensor. For example, the sensor senses that the suspension member 10 shown in FIG. 6 has moved to the position shown in FIG. 7, which causes the restricting member 32 to operate and limit the position of the suspension member 10.

The suspension member 10 connected to the flying vehicle 100 may be connected at an end different from the end connected to the flying vehicle 100 to a connection part 11 that includes a load to be transported, a case containing the load, a camera or sound-sensing equipment for photographing or inspecting, sensors, grain spraying equipment, liquid spraying equipment, inspection equipment, an acting part for a predetermined task, etc. The suspension member 10 and the load 11 may be connected in an automatic or manual disconnectable manner.

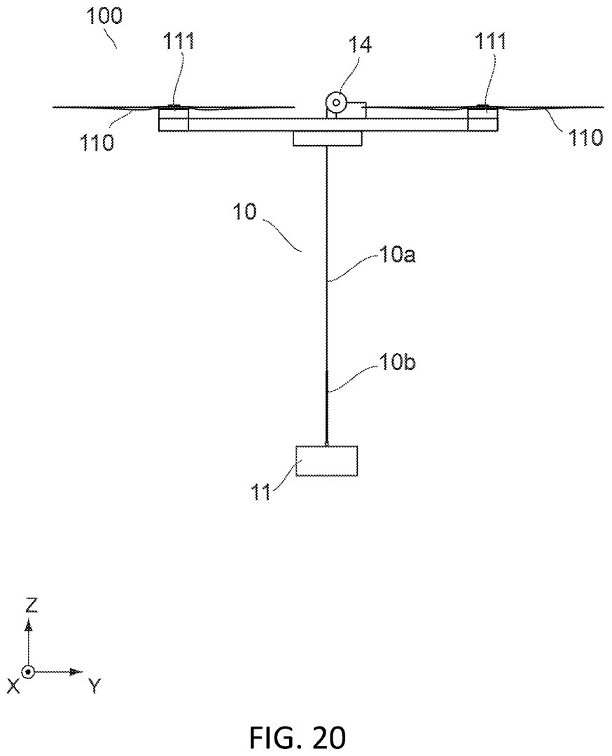

When the suspension member 10 comprises a material that can be wound onto a spool, such as a cable, wire, chain, cord. string, or the like, it can be unrolled or wound using a winch, hoist, or other winding machine 14 provided by the flying vehicle, as illustrated in FIGS. 19 and 20.

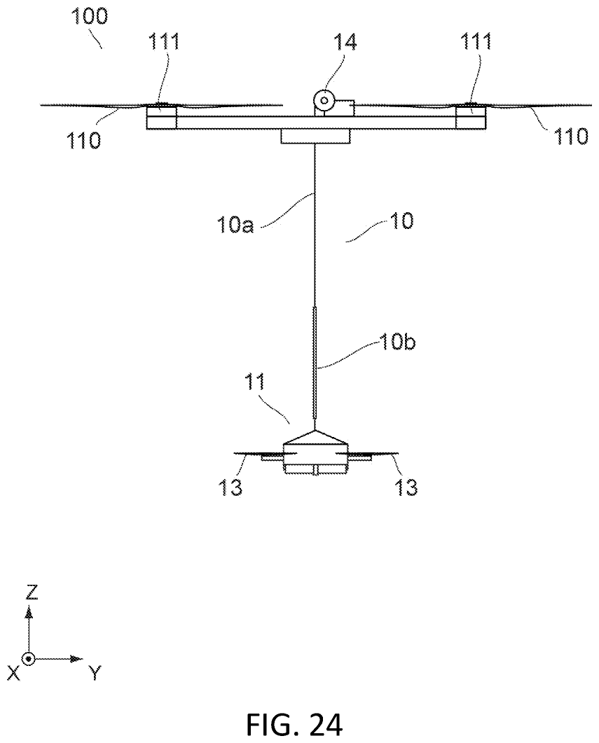

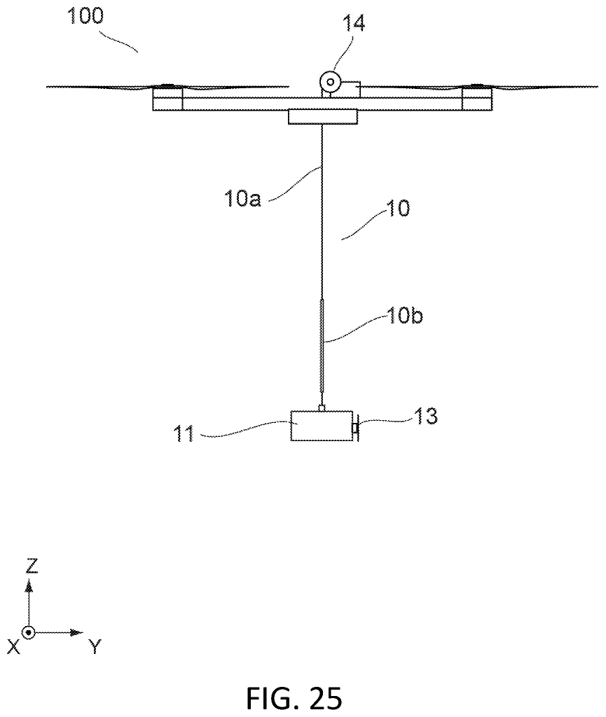

As illustrated in FIG. 24 and FIG. 25, the loading part 11 connected to the suspension member 10 may be equipped with suspension movement means 13 (e.g., a propeller, air blowing device, etc.). The suspension member 10 and the loading part 11 can move independently of the movement of the flying vehicle 100 by the suspension and lowering movement means 13. The suspension and lower movement means 13 may be provided only on one directional side with respect to the loading part 11. However, they may also be provided in at least two directions (e.g., in FIG. 25, the propulsion directions of the multiple suspension and lower portion movement means 13 are arranged 90 degrees apart, such as by providing a suspension and lower portion movement means 13 further to the front of the page) so that they can move freely in the XY direction.

The method of accommodating the suspension member 10 in the enclosed space 33 is, as illustrated in FIG. 1 and FIG. 2, by the flying vehicle 100 moving in planar motion or the load 11 connected to the suspension member 10 moving in planar motion, or by at least part of the position restriction device 30 and accommodated in the enclosed space 33.

When using the method where the position restriction device 30 approaches the suspension member 10, the position restriction device 30 is equipped with a structure, such as a robotic arm or rail system, that allows movement of the guiding part 31 and the restricting member 32 in at least one of the X, Y, or Z directions. This allows the flying vehicle 100 connecting the suspension member 10 to hover within a predetermined range to be position-restricted.

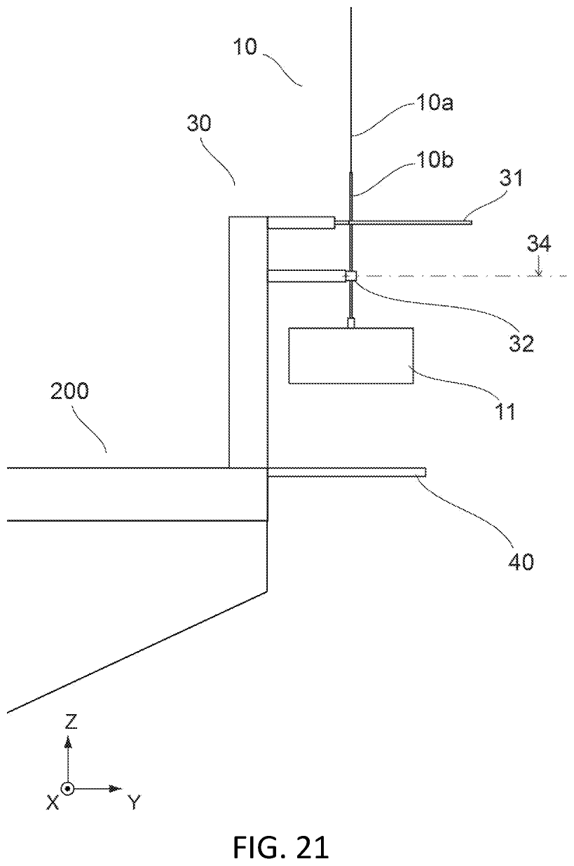

After the suspension member 10 enters the enclosed space 33, the movement of the suspension member 10 is restricted by the restricting member 32. For example, the movement can be restricted by using the restricting member 32 as a movable member and closing the open part, as shown in FIG. 3-FIG. 5 above, or by using the restricting member 32 as a gripping device or winding device and fixing it, as shown in FIG. 6-FIG. 8. FIG. 21-FIG. 23 show details of a case in which the restricting member 32 is used as a winding device or a gripping device to unload to the load receiving part 40.

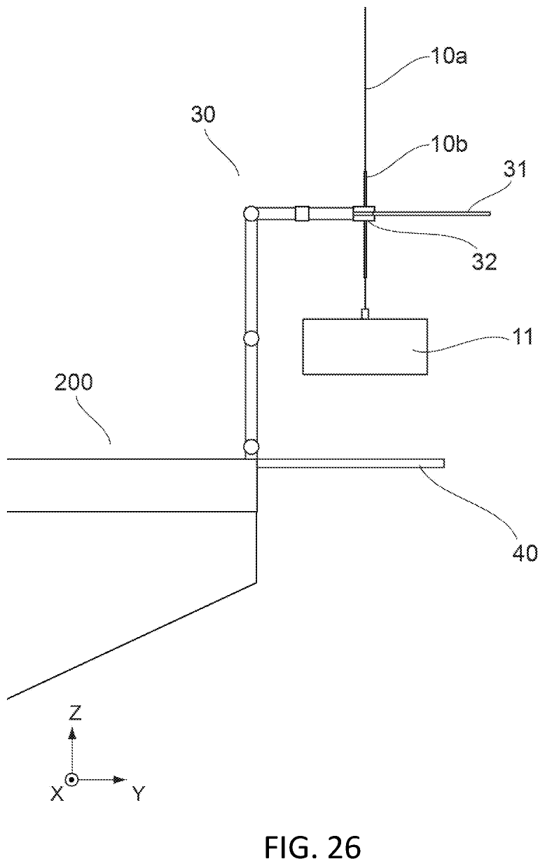

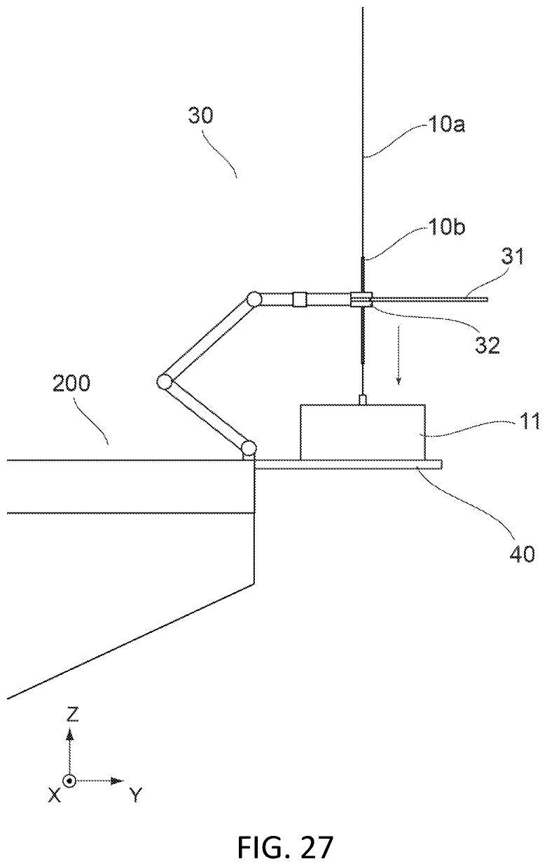

When the restricting part 32 is composed integrally as a winding part and a gripping part, as illustrated in FIG. 6-FIG. 8, or when having the function of gripping or fixing and moving the 10 suspension members, such as when it is separately configured as a winding device as illustrated in FIG. 21-FIG. 23, or as an arm with a gripping portion as illustrated in FIG. 26 and FIG. 27, and so on, it is possible to move the suspension member 10 to any desired position regardless of the movement of the flying vehicle 100 or the load 11. For example, when a delivery load is connected to the suspension member 10 and the position where the suspension member is grasped is not suitable for unloading with respect to the load receiving part 40, the height (Z-direction) or horizontal (XY-direction) position of the delivery load can be changed by the position restriction device 30, by winding up the load with the winding part (winding device) or by bending the arm or other deformation to make the height suitable for detaching the delivery load. This eliminates the need for position adjustment by equipment connected to the flying vehicle 100.

When the restriction member 32 is configured to grip the suspension member 10 (e.g., winding device, clamp, magnet, etc.), it is possible to use the position restriction device 30 to moor the flying vehicle 100. Furthermore, the winding device 14 can be used to limit the amount of planar movement of the flying vehicle 100 while allowing it to ascend and descend. This makes it possible to moor the flying vehicle 100 at a higher than predetermined altitude and have it descend and land while preventing unintended plane movement or out-of-control movement of the flying vehicle 100. Conversely, the flying vehicle 100 moored at a lower altitude can be released after ascending to a predetermined height, thereby preventing the plane movement or out-of-control movement of the flying object 100 until it ascends to the predetermined height.

For movement of the suspension member 10 and the mount 11 connected to the suspension member 10 by the position restriction device 30, the position restriction device 30 may be equipped with a winding device, arm, etc., as well as a sensor for recognizing the position of the object, etc., and a processing unit for obtaining the amount of movement, etc. This improves the accuracy of position control when moving the load 11 or flying vehicle 100 to a predetermined position.

While the position restriction device 30 is not in use, the position restriction device, including the guide part, may be partially or fully folded up or stored in a building or other structure, as illustrated in FIG. 26-FIG. 27. For example, if the device is stored under a roof or inside a structure that prevents exposure to wind, rain, or the like, deterioration and damage to the position restriction device may be prevented.

In recent years, various forms of flying vehicles have been considered and implemented for use in industries other than home delivery (e.g., inspection, survey, photography, surveillance, agriculture, disaster prevention, etc.). In some operational environments, it may be difficult to provide a landing space for flying vehicles. For example, when inspecting bridges at high elevations, there are cases where it is impossible to approach the bridges due to the distance from the ground, rivers, the sea, and other factors. In such cases, the flying vehicle can be used as a temporary takeoff and landing facility with the position restriction device 30 connected to the bridge to moor or grasp the flying vehicle.

The position restriction device 30 may be provided on a moving object (e.g., vehicle, vessel, railroad, flying vehicle, etc.). The moving object may be movable only within a predetermined range, or it may be unrestricted in its movement.

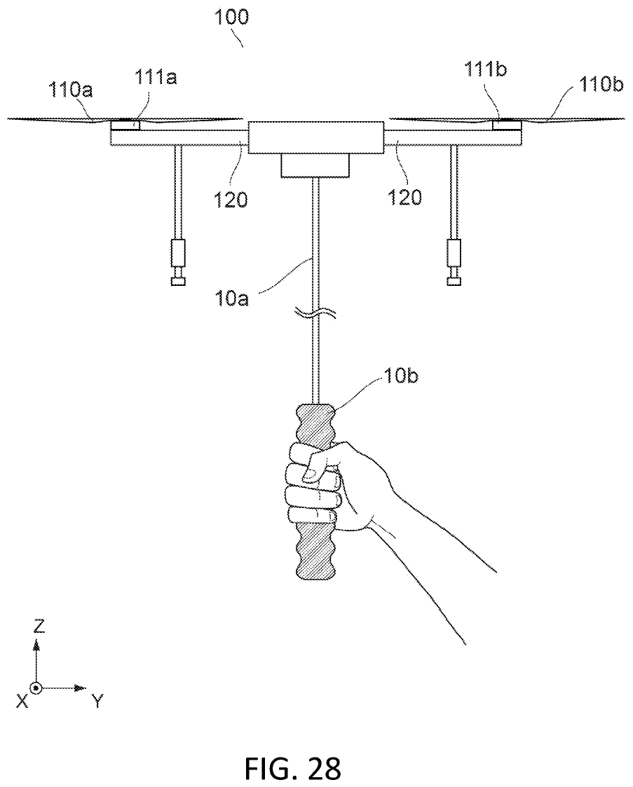

Although the use of the suspension member in combination with the position restriction device 30 has been described so far as an example, the suspension member according to the invention can also be a means of improving the ease of grasping and the ease of applying force when grasping by the human hand, as illustrated in FIG. 28.

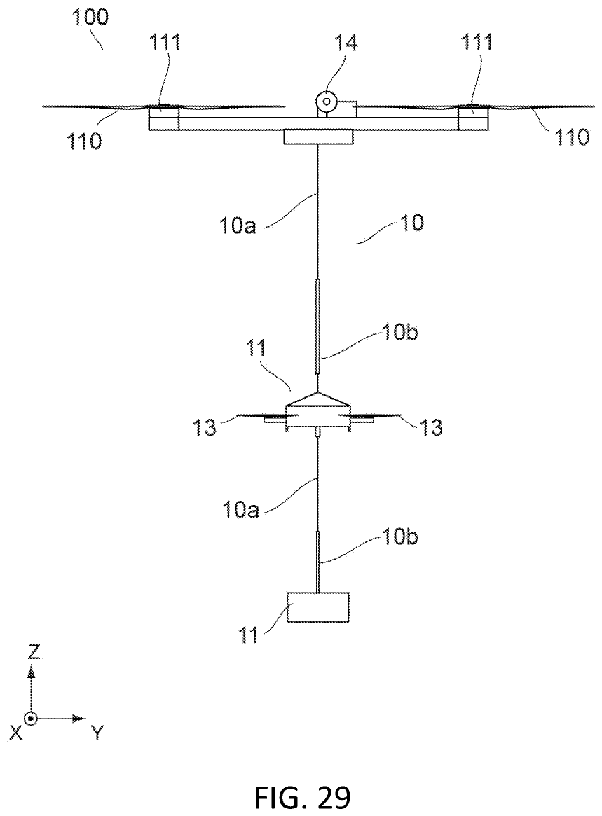

The location of the second portion 10b depends on the position of the position restriction device or other device acting on the suspension member. The second part 10b can be located between the first portions at both end of the part as shown in FIG. 1, or at the end of the first part 10a as illustrated in FIG. 20 and FIG. 28. When there is more than one portion to be gripped, there may be more than one second portion 10b in one suspension member 10, as illustrated in FIG. 29. In this case, the material and shape of the second portion 10b may be the same or different for each of them. On the other hand, in the configuration illustrated in FIG. 29, only the suspension member connected to the loading part 11 may be gripped, or only the suspension member connected to the flying vehicle 100 may be gripped, so that only one of the suspension members 10 may be provided with the second portion 10b.

The above mentioned embodiments are merely examples to facilitate understanding of the invention and are not intended to be construed as limiting the invention. It goes without saying that the invention may be changed and improved without departing from its purpose, and that the invention includes equivalents thereof. The features indicated in each embodiment are also applicable to other embodiments as long as they do not contradict each other.

### DESCRIPTION OF REFERENCE NUMERALS

10 Suspension member
10a First portion
10b Second portion
11 Load, baggage
13 Suspension movement means
14 Winding machine
30 Position restriction device
31 Guide part
32 Restricting member
33 Containment space (enclosed space)
34 Rotation axis
40 Load receiving part
100 Flying vehicle
110a-110e Propellers
111a-111e Motors
120 Frame
200 Structure

1. A flying vehicle comprises a suspension member suspending a load,
wherein the suspension member comprises a first portion and a second portion which is different in configuration from the first portion and which is to be grasped.

2. The flying vehicle according to claim 1,
wherein the first portion and the second portion are different cord-like members and are connected to each other.

3. The flying vehicle according to claim 1,
wherein the second portion is comprised of a member that is thicker than the first portion.

4. The flying vehicle according to claim 1,
wherein the second portion is covered by the covering member.

5. The flying vehicle according to claim 1,
wherein the second portion comprises a higher coefficient of friction than the first portion.

6. The flying vehicle according to claim 1,
wherein the first portion and the second portion have a common cord-like member,
wherein the second portion has a member covering the common cord-like member.

7. The flying vehicle according to claim 6,
wherein the member covering the common cord-like member is a covering member with a high coefficient of friction.

8. The flying vehicle according to claim 6,
wherein the member covering the common cord-like member is a member with a concave-convex shape on the surface.

9. The flying vehicle according to claim 1,
wherein the cross-sectional shape of the second portion is different from the cross-sectional shape of the first portion.

10. The flying vehicle according to claim 9,
wherein the cross-sectional shape of the second portion is polygonal.

11. The flying vehicle according to claim 1,
wherein the second portion is provided in the vicinity of the load.

12. The flying vehicle according to claim 1,
wherein the suspension member is connected to a loading part that carries the load.

13. The flying vehicle according to claim 12,
wherein the mounting part is equipped with a rotary wing part.

14. The flying vehicle according to claim 12,
wherein the suspending member comprises:
a first suspending member between the flying vehicle and the loading part; and
a second suspending member between the loading part and the load.

15. The flying vehicle according to claim 14,
wherein the first suspension member and the second suspension member both have the second portions.

16. The flying vehicle according to claim 14,
wherein the first suspension member has the second portion,
wherein the second suspension member does not have the second portion.

17. The flying vehicle according to claim 14,
wherein the first suspension member does not have the second portion,
wherein the second suspension member has the second portion.
